(19) United States
(12) Patent Application Publication
(10) Pub. No.: US 2004/0088253 A1
(43) Pub. Date: May 6, 2004

(54) Delinquent account payment system

(76) Inventors: Joseph A. Crispyn, Wilmington, DE (US); Richard H. Biedermann, Hockessin, DE (US); Henry S. Reimert, Bel Air, MD (US)

Correspondence Address: VENABLE, BAETJER, HOWARD AND CIVILETTI, LLP, P.O. BOX 34385, WASHINGTON, DC, 20043-9998, US

(21) Appl. No.: 10/284,293

(22) Filed: Oct. 31, 2002

(51) Int. Cl. G06F 17/60

(52) U.S. Cl. 705/40

(57) ABSTRACT

A method assists in payment of an account having a delinquent status. The method comprises: receiving a request via a network to access information regarding the account, where the account comprises an account identifier and an account balance; and providing at least one payment option for the account via the network, where each payment option changes the delinquent status of the account to a current status upon acceptance of the payment option.

### BACKGROUND OF THE INVENTION

1. Field of the Invention

The present invention relates generally to providing online payment options for a delinquent customer having a delinquent account with a lending organization. More particularly, the payment options are customized based on the account of the delinquent customer.

2. Related Art

In today's business environment, a company, such as a credit card company, a bank, a store or other lender, offers a large amount of credit or financing to a myriad of individuals and businesses. Currently, some companies (e.g., credit card companies) provide online access for each customer to obtain account information regarding an account (e.g., a credit card account) of the customer. The customer can access the account information from a web site via the Internet. Such account information generally available from the web site includes: balance information, payment information, available cash, total minimum payment due, and a transaction history.

Unfortunately, a customer sometimes falls behind in payment of the account. For example, a customer fails to pay a monthly bill payment for a credit card account. If an account is behind on payment, the account status is referred to as delinquent, the account is referred to as a delinquent account, and the customer is referred to as a delinquent customer. On the other hand, if an account is not behind on payment, the account status is referred to as current, the account is referred to as a current account, and the customer is referred to as a current customer.

To change the account status from delinquent to current, the company or its designee contacts the delinquent customer, typically by telephone, and attempts to identify the reason for the account status being delinquent and to work with the delinquent customer in changing the account status from delinquent to current. If the delinquent customer is not successfully contacted, a voice message is typically left requesting a telephone conference with the customer. Other techniques of contacting the delinquent customer include sending a notice by direct mail or e-mail (referred to as “dunning” letters) informing the delinquent customer of the account status and providing a telephone number for the delinquent customer to call. Once the delinquent customer is on the telephone, the delinquent customer is presented with payment options to change the account status of the customer from delinquent to current. Such telephone conversations often result in friction with the delinquent customer. Further, with the conventional approach, multiple telephone calls and/or dunning letters are typically required to change an account status from delinquent to current, which increases the costs of changing delinquent accounts to current accounts.

There is a need to decrease the number of delinquent accounts. There is another need to decrease the amount of friction caused in contacting delinquent customers. There is another need to reduce to the cost of changing an account status from delinquent to current.

### SUMMARY OF THE INVENTION

The method of the invention includes a method for assisting in payment of an account having a delinquent status. The method comprises the steps of: receiving a request via a network to access information regarding the account, where the account comprises an account identifier and an account balance; and providing at least one payment option for the account via the network, where each payment option changes the delinquent status of the account to a current status upon acceptance of the payment option.

The system of the invention includes a computer system including at least one computer-readable medium having software to operate a computer in accordance with the invention.

The apparatus of the invention includes a computer including at least one computer-readable medium having software to operate the computer in accordance with the invention.

The article of manufacture of the invention includes a computer-readable medium having software to operate a computer in accordance with the invention.

Further, the system of the invention includes a computer system for assisting in payment of an account having a delinquent status. The computer system comprising at least one computer-readable medium. The at least one computer-readable medium comprises: a delinquent accounts database, where the delinquent accounts database comprises an account identifier and an account balance for the account; and software to provide at least one payment option for the account via a network, where each the payment option changes the delinquent status of the account to a current status upon acceptance of the payment option, where each the payment option is based on the account balance from the delinquent accounts database.

In addition, the system of the invention includes a computer system for assisting in payment of an account having a delinquent status. The computer system comprises at least one computer-readable medium. The at least one computer-readable medium comprises: software to provide a login web page via a network, where the login web page requests an account identifier for the account; software to provide a payment options web page via the network, where the payment options web page provides at least one payment option for the account via a network, where each the payment option changes the delinquent status of the account to a current status upon acceptance of the payment option, where each the payment option is based on an account balance of the account; software to provide a payment methods web page via the network, where the payment methods web page provides at least one payment option for paying down the account based on the payment options; and software to provide a budget worksheet web page via the network, where the budget worksheet web page provides a budget analysis based on at least one of the payment options.

Further features of the invention, as well as the structure and operation of various embodiments of the invention, are described in detail below with reference to the accompanying drawings.

Definitions

A “computer” refers to any apparatus that is capable of accepting a structured input, processing the structured input according to prescribed rules, and producing results of the processing as output. Examples of a computer include: a computer; a general purpose computer; a supercomputer; a mainframe; a super mini-computer; a mini-computer; a computer; a micro-computer; a server; an interactive television; a web appliance; a telecommunications device with internet access; a hybrid combination of a computer and an interactive television; and application-specific hardware to emulate a computer and/or software. A computer can be stationary or portable. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” refers to any storage device used for storing data accessible by a computer. Examples of a computer-readable medium include: a magnetic hard disk; a floppy disk; an optical disk, such as a CD-ROM and a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include: software; code segments; instructions; computer programs; and programmed logic.

A “computer system” refers to a system having a computer, where the computer comprises a computer-readable medium embodying software to operate the computer.

A “network” refers to a number of computers and associated devices that are connected by communication facilities. A network involves permanent connections such as cables or temporary connections such as those made through telephone, wireless, or other communication links. Examples of a network include: an internet, such as the Internet; an intranet; a local area network (LAN); a wide area network (WAN); and a combination of networks, such as an internet and an intranet.

### BRIEF DESCRIPTION OF THE DRAWINGS

The foregoing and other features and advantages of the invention will be apparent from the following, more particular description of a preferred embodiment of the invention, as illustrated in the accompanying drawings. The left most digits in the corresponding reference number indicate the drawing in which an element first appears.

FIG. 1 illustrates a plan view of a computer system of the invention;

FIG. 2 illustrates a site map for a web site of the invention;

FIG. 3 illustrates a flowchart for logging in via a login web page;

FIG. 4 illustrates an exemplary login web page;

FIG. 5 illustrates an exemplary payment options web page;

FIG. 6 illustrates an exemplary payment option detail web page;

FIG. 7 illustrates an exemplary payment option detail web page;

FIG. 8 illustrates an exemplary payment methods web page;

FIG. 9 illustrates an exemplary budget worksheet web page.

### DETAILED DESCRIPTION OF EXEMPLARY EMBODIMENTS OF THE INVENTION

Exemplary embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention. The embodiments and examples discussed herein are non-limiting examples.

With the invention, a lending organization lends money or provides financing, credit, or the like to a customer via an account with the lending organization. Examples of a lending organization using the invention include: a credit card company, a debit card company, a bank, a savings and loan, a brokerage firm, a financial institution, a department store, a store selling goods and/or services, a catalogue merchant, a store, a telecommunications company, a utility company, an Internet-based company, a rewards program provider, a technology provider for such organizations, a lender, or the like. Examples of an account using the invention include: a credit card, a debit card, a loan account, an account with one of the exemplary lending organizations listed above, or the like. Examples of a customer using the invention include: a person, persons, a business, a legal entity, or the like.

The lending organization provides payment options online for a delinquent customer having a delinquent account with the lending organization. The payment options are customized based on the account of the delinquent customer. The payment options assist the delinquent customer with changing the account status from delinquent to current.

The online nature of the payment options assists in decreasing the friction with the delinquent customer. With the invention, the delinquent customer can access the account information online, view the payment options online, select a payment option online, and make payment online or offline. With the invention, all of these interactions with the lending organization are performed without human interaction and, hence, help to diffuse a potentially confrontational situation. The delinquent customer can perform these various tasks without interfacing with a representative of the lending organization.

As an option, the delinquent customer can select the payment option via a telephone conversation with a representative of the lending organization. This option still assists in reducing friction with the delinquent customer because the delinquent customer is notified of the payment options and has an opportunity to consider the payment options before contacting the lending organization.

The invention also provides online access for the delinquent customer to budgeting tools that allow the delinquent customer to forecast payment amounts and reallocate finances to determine which payment option is best. This feature of the invention additionally helps to relieve friction during interaction between the delinquent customer and a representative of the lending organization. The delinquent customer is able to explore and consider the various payment options at the delinquent customer's own pace.

Further, with the invention, the cost can be reduced for changing an account status from delinquent to current. The need for a representative to attempt to telephone a delinquent customer can be a significant driver in the cost of changing a delinquent account to a current account. By eliminating or significantly reducing the time a representative needs to interact with a delinquent customer, the cost of bringing a delinquent account to a current status can be reduced with the invention.

Overall, the invention can assist with decreasing the number of delinquent accounts of the lending organization. With the invention, delinquent customers are presented with various payment options and are able to take the time to understand and consider these payment options without the need for interacting with a representative of the lending organization. This can lead to decreasing the number of delinquent accounts of the lending organization and, thereby, increasing the robustness of the lending organization.

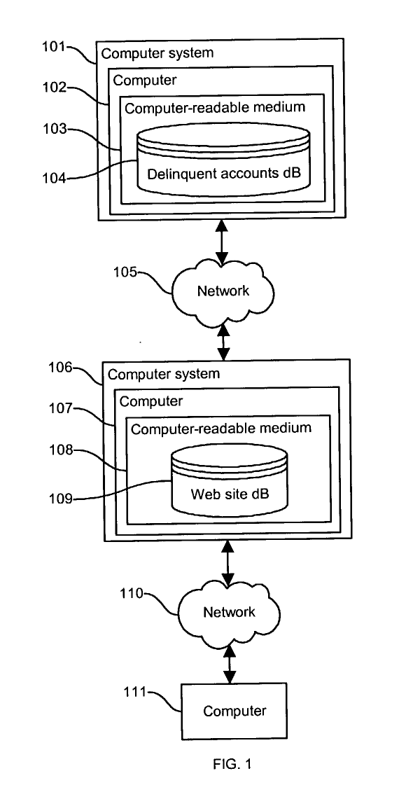

FIG. 1 illustrates a plan view of a computer system of the invention. The computer system of the invention includes a computer system 101 and a computer system 106 connected via a network 105. The computer system 101 includes a computer 102, which includes a computer-readable medium 103. The computer-readable medium 103 includes a delinquent accounts database 104. The delinquent accounts database 104 includes information on delinquent accounts of the lending organization. The computer system 101 maintains the account information for accounts of the customers. Via the network 105, the computer system 101 transfers data having needed account information to the computer system 106. The data transfers can occur periodically or aperiodically.

The delinquent accounts database 104 maintains information on delinquent accounts of the lending organization. Each delinquent account includes information regarding, for example, an account identifier and an account balance. Examples of the account identifier include: an account number; a customer name; a user identification number; a social security number; and a zip code. The account balance identifies the amount owed by the customer to the lending organization. Each delinquent account can include other information, for example: an account history; a payment due date; and a budget worksheet.

The delinquent accounts database 104 can be the same as or separate from a database maintaining information on all accounts of the lending organization.

The computer system 106 includes a computer 107, which includes a computer-readable medium 108. The computer-readable medium 108 includes a web site database 109. The computer system 106 operates a web site of the invention. The web site database 109 includes information for operating the web site of the invention. The computer system 106 can be, for example, a web server. The computer system 106 operates the web site using data stored in the account database 104 and received from the computer system 101.

Via a network 110, the computer system 106 interacts with a computer 111 of a customer. Via the network 110 and the computer 111, the customer accesses the web site regarding payment options for a delinquent account. The computer 111 includes, for example, a web browser to interact with the web site maintained by the computer system 106. As an option, the computer 111 can be a computer system.

As an option, the computer systems 101 and 106 are implemented as a single computer system.

A delinquent customer can be guided to the web site of the invention in a number of ways. The uniform resource locator (URL) for the web site of the invention can be provided to the delinquent customer through a number of marketing techniques. For example, the URL can be included as a hyperlink in a targeted e-mail, provided in a direct mailing, provided on a voice-mail message left on an answering machine of the delinquent customer, or included on the account statement of the delinquent customer. In addition, multiple URLs can be set up to direct the delinquent customer to the web site of the invention. The URL can also be provided to the delinquent customer via one or more web sites and/or web pages accessed by the delinquent customer.

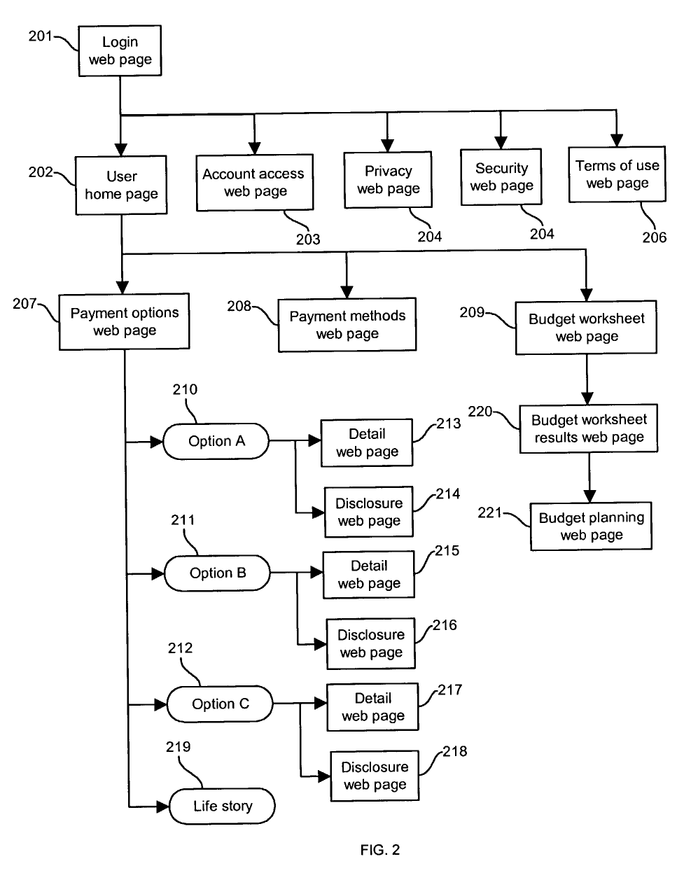

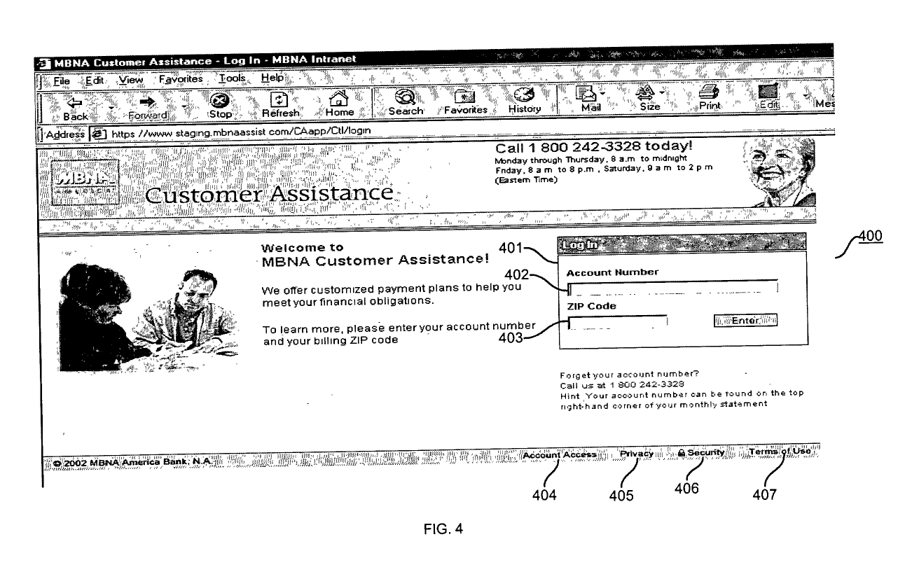

FIG. 2 illustrates a site map for the web site of the invention. FIGS. 4-9 illustrate exemplary web pages for the web pages in the site map of FIG. 2. The exemplary web pages in FIGS. 4-9 are for a lending organization and for an account that is a credit card, or other type of loan account. The exemplary web pages in FIGS. 4-9 are for an exemplary web site employing the invention.

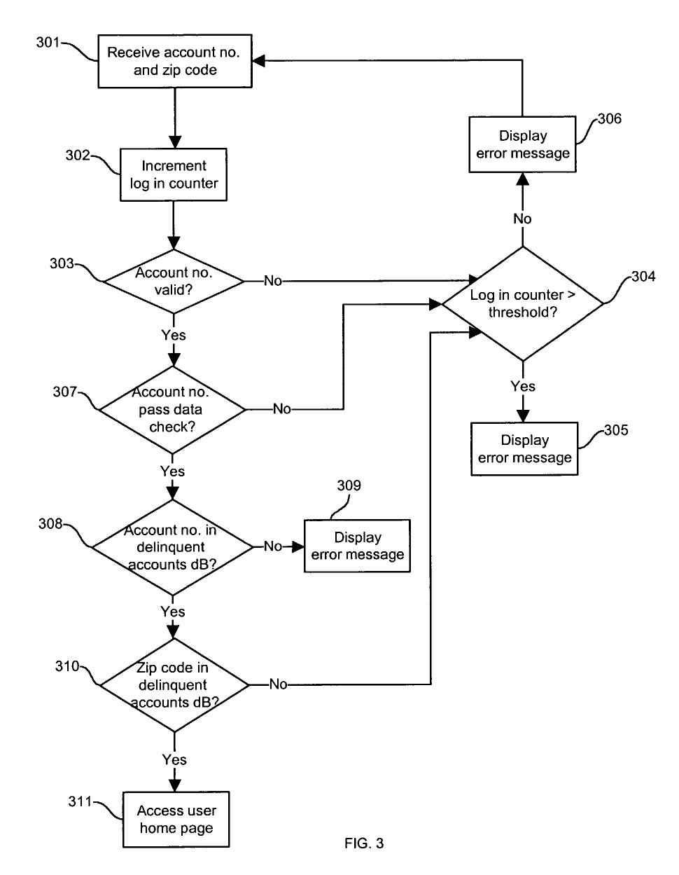

Via a login web page 201, a customer logs in to the web site of the invention. In logging in, the customer is requesting to access information on the account of the customer, and the computer system 106 receives this request from the computer 111 via the network 110. FIG. 3 illustrates a flowchart for logging in via the login web page 201, and FIG. 4 illustrates an exemplary login web page 400 for the login web page 201.

In block 301, the web site receives an account number and a zip code from the customer attempting to login to the web site. A login area 401 is provided on the exemplary login web page 400. The login area 401 includes a field 402 for entering an account number and a field 403 for entering a zip code. Once the account number and zip code are entered, they are forwarded from the computer 111 to the computer system 106, and the flow proceeds to block 302.

In block 302, a login counter is incremented by one.

In block 303, the account number is analyzed to determine if the account number is valid.

For example, if all account numbers have either 14 or 16 digits, the account number is analyzed to determine if 14 or 16 digits was entered. The computer system 106 determines if the account number is valid. If the account number is not valid, flow proceeds to block 304. If the account number is valid, flow proceeds to block 307.

In block 304, the login counter is compared to a threshold, for example, of three. If the login counter is less than the threshold, flow proceeds to block 306. If the login counter is greater than or equal to the threshold, flow proceeds to block 305. With the login counter, the number of attempts to login to the web site of the invention is limited.

In block 305, an error message is displayed, and the customer is directed to contact a customer assistance telephone number. The error message can be nondescript or provide details as to why the login was unsuccessful.

In block 306, an error message is displayed. The error message can be nondescript or provide details as to why the login was unsuccessful. The customer is prompted to enter another account number and zip code pair, and flow proceeds back to block 301.

In block 307, a data check is performed on the account number. To conduct the data integrity check, the entered account number can be hashed. For example, if a sixteen-digit account number is entered, a data integrity check is performed by hashing, and if a fourteen-digit account number is entered, a data integrity check is performed by hashing, and the account is examined to determine the type of account (e.g., credit card or non-credit card). The computer system 106 performs the data check. If the account number fails the data check, flow proceeds to block 304. If the account number passes the data check, flow proceeds to block 308.

In block 308, the account number is compared to account numbers in the delinquent accounts database 104 provided to the computer system 106. The computer system 106 performs the comparison. As an option, the computer system 101 performs the comparison. If the account number is not in the delinquent accounts database 104, flow proceeds to block 309. If the entered account number is in the delinquent accounts database 104, flow proceeds to block 310.

In block 309, an error message is displayed, and the customer is directed to another area of the web site. The error message can be nondescript or provide details as to why the login was unsuccessful (e.g., stating that the account number is no longer delinquent).

In block 310, the entered zip code is compared to the corresponding zip code for the entered account number in the delinquent accounts database 104 provided to the computer system 106. The computer system 106 performs the comparison. As an option, the computer system 101 performs the comparison. If the entered zip code does not correspond to the entered account number, flow proceeds to block 304. If the entered zip code corresponds to the entered account number, flow proceeds to block 311.

In block 311, the customer is permitted access to the user home page 202.

As illustrated in FIG. 4, the exemplary login web page includes links to other areas of the web site. For example, the exemplary login web page 400 includes a link 404 to an account access web page 202, a link 405 to a privacy web page 203, a link 406 to a security web page 204, and a link 407 to a terms of use web page 205. The account access web page 202 provides access to account information for a customer and may require further log in by the customer. The privacy web page 202 provides information on the privacy policies of the lending organization. For example, the privacy web page 203 describes the policy regarding use of information supplied to the web site by the customer. The security web page 204 provides the security policy of the lending organization and, for example, states that interaction with the web site is secure through industry acknowledged methods (e.g., SSL). The terms of use web page 205 provides the restrictions for using the web site.

As an option to the flowchart of FIG. 3, instead of using the account number and zip code of the customer, other types of information can be used to identify and/or authenticate the customer for access to the web site. For example, a user name, a customer-generated login name, and/or a password can be used in conjunction with and/or instead of the account number and/or the zip code of the customer. With other types of information and/or other types of information combinations, the same and/or different checks on the information can be performed other than those illustrated in FIG. 3 for blocks 303, 307, 308, and 310. The various combinations of identification and/or authentication information and checks on such information will become apparent to those of ordinary skill in the art.

Once the customer logs in successfully, the customer is provided with the user home page 202. In this example, the user home page defaults to a payment options web page 207. The user home page 202 includes a tab for the payment options web page 207 (where the tab is highlighted to indicate to the customer that the options web page 207 is being viewed), a link to a payment methods web page 208, and a link to a budget worksheet web page 209. With this default, the customer does not first need to choose a tab or link. Instead, the customer can review the payment options and thereafter select an option without first needing to select one of the three web pages 207, 208, or 209.

The payment options web page 207 presents the delinquent customer with at least one payment option to change the account status of the delinquent account from delinquent to current. Each payment option presented to the delinquent customer is customized for the delinquent customer. The delinquent customer receives a selection of possible payment options, and each payment option offered to the delinquent customer is customized to include payoff information specific to the delinquent account. The payment option can be based on a combination of one or more of the following information regarding the delinquent account: the account balance; account status (e.g., 30, 60, 90, 120, 150, or 180 days delinquent); and account history.

A number of payment options are predetermined by the lending organization to be offered to delinquent customers. Examples of possible payment options include: paying the past due amount in full; paying off the existing balance at a reduced rate; paying off a percentage of the existing balance at the same interest rate; and paying off a percentage of the existing balance at a reduced interest rate.

For each offered payment option, customized payment option data is determined. Examples of customized payment option data include: account balance; payoff amount; number of payments; interest rate; interest rate term; payment option deadline; whether payment option can be accepted online; URL to accept payment option; whether payment option can be accepted via a telephone call; telephone number to call to accept payment option; whether payment can be mailed; and the mailing address for mailing payments.

The computer system 101 determines which payment options to offer the delinquent customer based on, for example, account balance, account status, and/or account history.

As illustrated in the site map of FIG. 2, up to three options are presented, namely: option A content 210, option B content 211, and option C content 212. More or less than three options can be presented to the delinquent customer. Each payment option includes links to a detailed web page and a disclosure web page. Specifically, option A content 210 includes a link to a detailed web page 213 and a link to a disclosure web page 214. The option B content 211 includes a link to a detailed web page 215 and a disclosure web page 216. Option C content 212 includes a link to a detailed web page 217 and disclosure web page 218. The detailed web pages 213, 215, and 217 provide details as to each respective payment option. The disclosure web pages 214, 216, and 218 provide legal disclosure text with terms for each respective payment option.

The computer system 101 determines which payments are to be offered to the delinquent customer and further determines the customized payment option data. The computer system 101 forwards the determined payment options and the customized payment option data to the computer system 106 via the network 105 periodically (e.g., in a batch mode a maximum of once daily) or aperiodically. The computer system 106 populates the payment options web page 207 with the determined payment options and the customized payment option data received from the computer system 101.

The payment options web page 207 also includes a life story content 219 extolling the virtues of the lending organization and/or the benefits of changing an account status from delinquent to current. The life story content 219 can include revolving content.

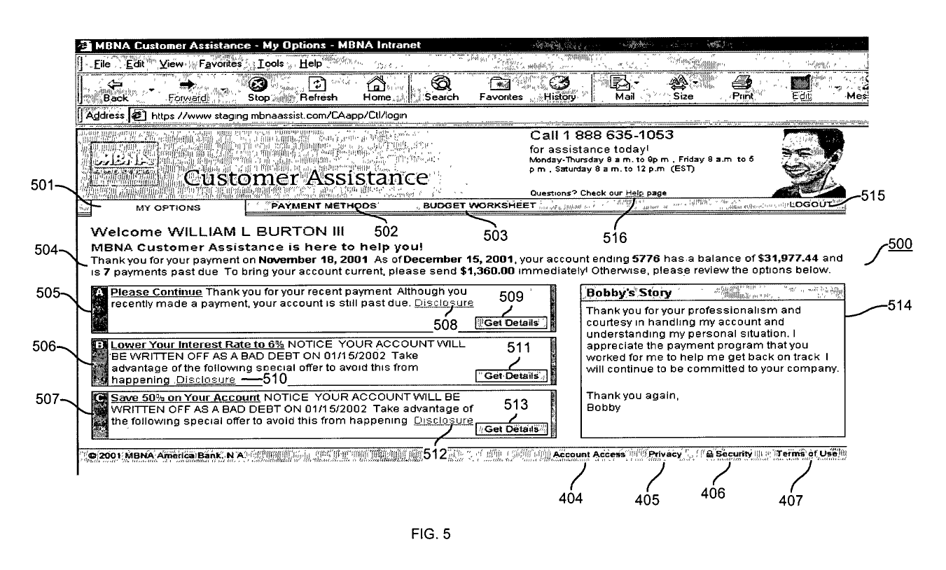

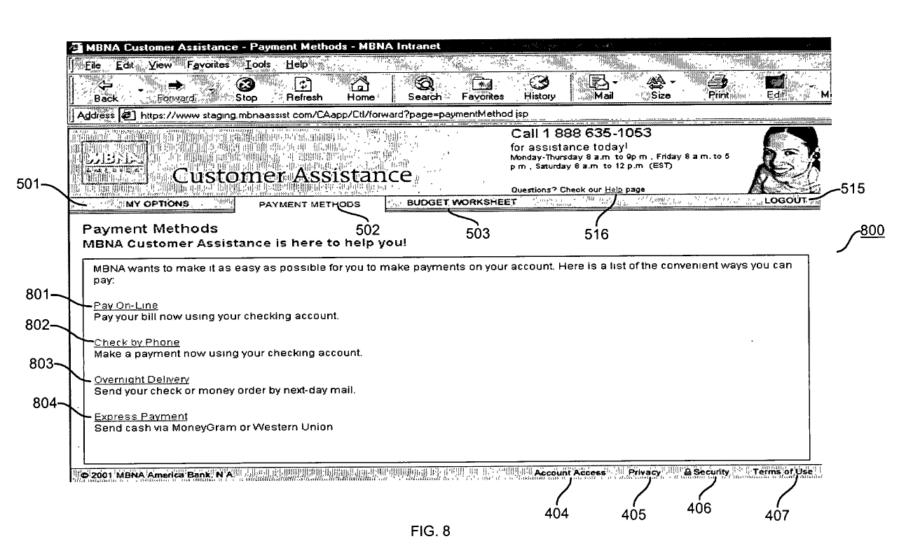

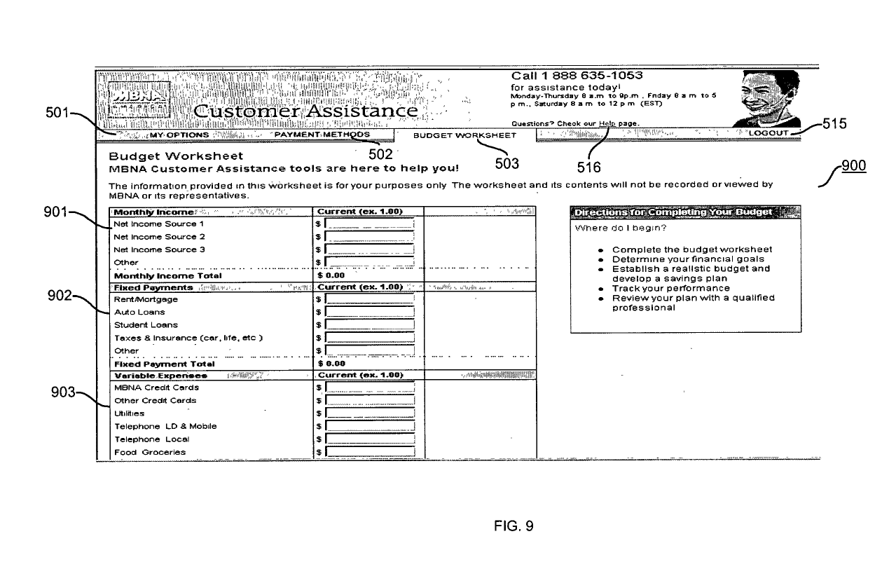

FIG. 5 illustrates an exemplary payment options web page 500, which is an example of the payment options web page 207. The payment options web page 500 includes a link 501 to the exemplary payment options web page 500, a link 502 to an exemplary payment methods web page 800 (FIG. 8), and a link 503 to an exemplary budget worksheet web page 900 (FIG. 9). The payment options web page 500 further includes account information 504, which includes, for example: the last payment date of the account, the balance due on the account, and how many payments are past due on the account.

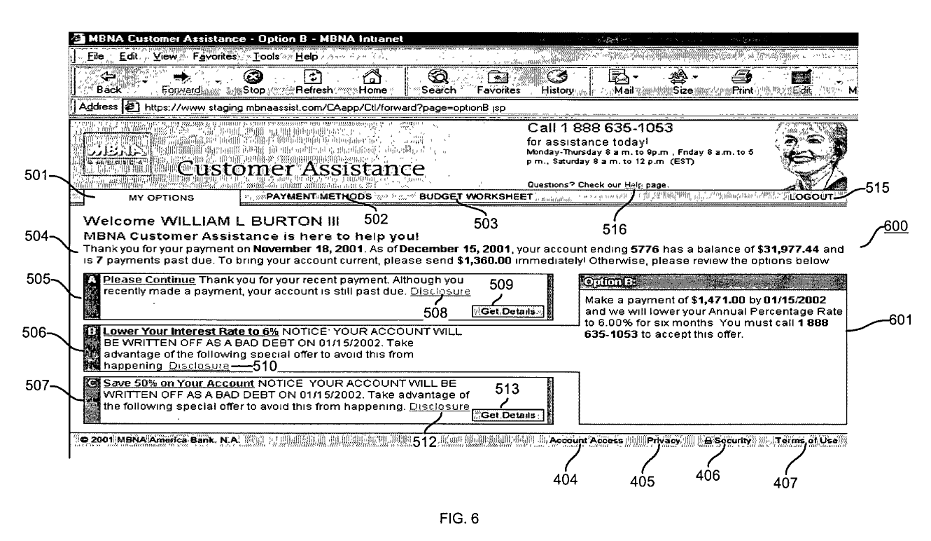

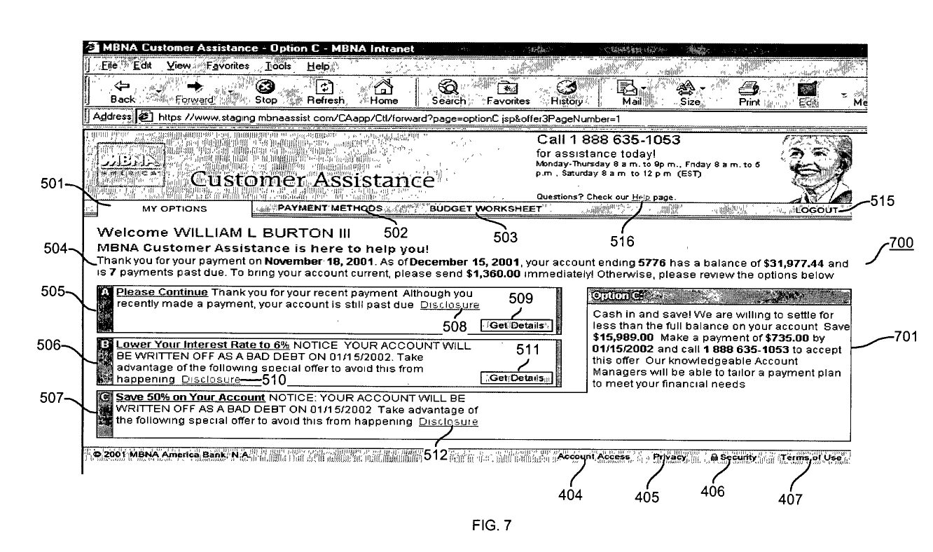

The exemplary web page 500 includes three options, namely option A content 505, option B content 506, and option C content 507. Each of the three options 505-507 includes links to respective detail web pages and description web pages. Specifically, option A content 505 includes link 508 to description web page 214 and link 509 to detail web pages 213. Option B content 506 includes link 510 to description web page 216 and link 511 to exemplary option B detail web pages 600 (FIG. 6). Option C content 507 includes link 512 to description web page 218 and link 513 to exemplary option C detail web pages 700 (FIG. 7). A life story content 514 is additionally displayed, and a link 515 provides for logging out of the web site. A link 516 accesses a help page of frequently asked questions (FAQs) and their corresponding answers. The payment options web page 500 additionally includes links 404, 405, 406, and 407 to the account access web page 202, the privacy web page 203, the security web page 204, and the terms of use web page 205, respectively.

Option A content 505 describes a payment option to pay the past due amount in full. Option B content 506 describes a payment option to pay the existing balance in full at a reduced interest rate. An option C content 507 provides a payment option to pay a percentage of the existing balance at the same interest rate.

FIG. 6 illustrates an exemplary payment option B detail web page 600, which is an example of detail web page 215. If the link 511 in the payment options web page 500 is selected (see FIG. 5), payment option B detail web page 600 is presented to the delinquent customer. The web page 600 includes option B content 601 describing further details of option B. The content 601 includes, for example: a payment amount; a payment due date; a new reduced interest rate; and a term for the new reduced interest rate. To accept payment option B, the delinquent customer is directed to contact the credit card company at the telephone number provided in content 601. As an option, a link can be provided in the content 601 to access additional information on the payment option B. For example, the additional information provided by the optional link continues the description of the payment option if the text in the content 601 exceeds space parameters for the content 601.

FIG. 7 illustrates an exemplary payment option C detail web page 700, which is an example of detail web page 217. If the delinquent customer selects link 513 in the payment options web page 500, the payment option C detail web page 700 is provided to the delinquent customer. An option C content 701 provides details of option C. The details provided include, for example: a payment due, a payment due date, and an amount saved. To accept payment option C, the delinquent customer is directed to contact the credit card company at the telephone number provided in content 701. As an option, a link can be provided in the content 701 to access additional information on the payment option C. For example, the additional information provided by the optional link continues the description of the payment option if the text in the content 701 exceeds space parameters for the content 701.

To accept one of the payment options, the delinquent customer can be required to contact the lending organization via the telephone, as illustrated with the option B content 601 and the option C content 701. Alternatively, the delinquent customer can accept one of the payment options by mailing in the payment by a due date or by clicking on a link on the web site.

The payment methods web page 208 advises the delinquent customer of at least one option that is available to make a payment for an accepted payment option. Examples of possible payment methods include: making a payment on-line; making a payment over the telephone using a checking account; sending a payment via overnight delivery; and making payment via a wire service.

FIG. 8 illustrates an exemplary payment methods web page 800, which is an example of the payment methods web page 208. The web page 800 includes a listing of the various payment methods available to the delinquent customer and links to further details on how to make payment according to the payment methods. Link 801 provides access to a payment on-line web page. Link 802 provides access to a web page describing how to make a payment via the telephone and a checking account. Link 803 provides access to a web page describing how to make a payment by sending a check or money order via overnight delivery. Link 804 provides access to a web page describing how to make payment via a money wire service.

The budget worksheet web page 209 assists the delinquent customer in determining current income and expenses based on the payment options from the payment options web page 207 and provides the delinquent customer with an opportunity to recalculate a budget by manipulating expense values. With the budget worksheet web page 209, the delinquent customer can generate a monthly budget and determine which of the payment options better provides for the lifestyle of the delinquent customer.

The budget worksheet web page 209 includes fields for the delinquent customer to enter information regarding monthly income, fixed payments, and variable expenses. Once entries are included for each of the fields, the delinquent customer is provided a link to calculate the budget, and a budget worksheet results web page 220 is presented. The budget results web page 220 presents the delinquent customer with a budget based on at least one payment option. The payment option used to determine the budget results web page 220 can be selected by the delinquent customer, the computer system 101, or the computer system 106. The budget worksheet results web page 220 includes a link to a budget planning web page 221. The budget planning web page 221 provides the delinquent customer with helpful information or “tips” to assist the delinquent customer with financial planning.

FIG. 9 illustrates an exemplary budget worksheet web page 900, which is an example of the budget worksheet web page 209. Monthly income area 901 provides fields for entering data regarding monthly income of the delinquent customer. The fields for the monthly income area 901 include: three net income sources; and one other income source. The fixed payments area 902 includes fields for entering data regarding fixed payments of the delinquent customer. The fields of the fixed payments area 902 include: rent/mortgage; auto loans; student loans; taxes and insurance; and other fixed payments. The variable expenses area 903 includes fields for entering data regarding variable expenses of the delinquent customer. The fields of the variable expenses area 903 include: credit cards of the lending organization; credit cards from other lending organizations; utilities; long distance telephone; mobile telephone; local telephone; groceries; dining out; childcare; auto/transportation; education; entertainment (not including food); and other variable expenses.

Once the areas 901-903 have sufficient information, three links appear on the web page 900, namely a calculate link, a print page link, and a reset link. The calculate link provides access to the budget worksheet results web page 220. The print page link allows the delinquent customer to print the budget worksheet web page 900 in a printer-friendly format. The reset link allows the delinquent customer to reset all the fields in the areas 901-903 and re-enter new information for the various fields.

As an option, web pages 207-221 all have links to web pages 203-205. For example, exemplary web pages 400, 500, 600, 700, and 800 include links 404, 405, 406, and 407.

Although the invention has been described for use with web sites and web pages, other types of networking, network devices, and network information can be used with the invention, as will be appreciated by those skilled in the art.

The embodiments and examples discussed herein are non-limiting examples.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for assisting in payment of an account having a delinquent status, comprising the steps of:
receiving a request via a network to access information regarding said account, said account comprising an account identifier and an account balance; and
providing at least one payment option for said account via said network, each said payment option to change the delinquent status of said account to a current status upon acceptance of said payment option.

2. A method as in claim 1, wherein each said payment option is customized to said account.

3. A method as in claim 1, further comprising the step of selecting each said payment option from a plurality of possible payment options.

4. A method as in claim 1, further comprising the steps of:
receiving an acceptance of one payment option; and
providing information via said network for at least one payment method for receiving payment for said accepted payment option.

5. A method as in claim 4, wherein said acceptance is received a telephone call.

6. A method as in claim 4, wherein said acceptance is received via said network.

7. A method as in claim 4, further comprising the step of receiving payment for said accepted payment option via said network.

8. A method as in claim 1, further comprising the step of:
receiving information for a budget worksheet via said network; and
providing budget worksheet results via said network, said budget worksheet results based on at least one payment option.

9. A method as in claim 1, wherein said request comprises an account number and a zip code for said account.

10. A method as in claim 1, wherein said account is a credit card or loan account.

11. A computer system comprising a computer-readable medium having software to operate a computer in accordance with the method of claim 1.

12. A computer-readable medium having software to operate a computer in accordance with the method of claim 1.

13. A computer system for assisting in payment of an account having a delinquent status, said computer system comprising at least one computer-readable medium, said at least one computer-readable medium comprising:
a delinquent accounts database, said delinquent accounts database comprising an account identifier and an account balance for said account; and
software to provide at least one payment option for said account via a network, each said payment option to change the delinquent status of said account to a current status upon acceptance of said payment option, each said payment option based on said account balance from said delinquent accounts database.

14. A computer system for assisting in payment of an account having a delinquent status, said computer system comprising at least one computer-readable medium, said at least one computer-readable medium comprising:
software to provide a login web page via a network, said login web page requesting an account identifier for said account;
software to provide a payment options web page via said network, said payment options web page providing at least one payment option for said account via a network, each said payment option to change the delinquent status of said account to a current status upon acceptance of said payment option, each said payment option based on an account balance of said account;
software to provide a payment methods web page via said network, said payment methods web page providing at least one payment option for paying down said account based on said payment options; and
software to provide a budget worksheet web page via said network, said budget worksheet web page providing a budget analysis based on at least one of said payment options.
